(19) United States
(12) Patent Application Publication
(10) Pub. No.: US 2013/0147097 A1
(43) Pub. Date: Jun. 13, 2013

(54) METHOD FOR FORMING A PREFORM FOR A CONTAINER

(71) Applicants: MICHAEL T. LANE, Brooklyn, MI (US); Kirk Edward Maki, Tecumseh, MI (US); George David Lisch, Jackson, MI (US); Luke A. Mast, Brooklyn, MI (US); Brad Wilson, Manchester, MI (US); Walt Paegel, Jackson, MI (US)

(72) Inventors: MICHAEL T. LANE, Brooklyn, MI (US); Kirk Edward Maki, Tecumseh, MI (US); George David Lisch, Jackson, MI (US); Luke A. Mast, Brooklyn, MI (US); Brad Wilson, Manchester, MI (US); Walt Paegel, Jackson, MI (US)

(21) Appl. No.: 13/490,499

(22) Filed: Jun. 7, 2012

Related U.S. Application Data
(60) Provisional application No. 61/495,098, filed on Jun. 9, 2011.

(51) Int. Cl. B29C 49/00; B65D 1/02; B29D 22/00

(52) U.S. Cl. CPC B29C 49/0073; B29D 22/003; B65D 1/0207
USPC 264/524; 428/36.92

(57) ABSTRACT

A preform for use in a system for simultaneously forming and filling a container. The preform includes a finish region, a stretch initiation region adjacent to and descending from the finish region, a transition region adjacent to and descending from the stretch initiation region, a body region adjacent to and descending from the transition region, and an end cap region enclosing an end of the body region to define an interior for receiving a forming fluid. The stretch initiation region defines a wall thickness less than a wall thickness of the body region to encourage initial localized stretching in response to the forming fluid prior to stretching within the transition region or body region.

### CROSS-REFERENCE TO RELATED APPLICATIONS

This application claims the benefit of U.S. Provisional Application No. 61/495,098, filed on Jun. 9, 2011. The entire disclosure of the above application is incorporated herein by reference.

### FIELD

This disclosure generally relates to forming and filling a plastic container. More specifically, this disclosure relates to an apparatus and method for forming a preform for use in simultaneously forming and filling a plastic container.

### BACKGROUND

This section provides background information related to the present disclosure which is not necessarily prior art.

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and ρ_{c} is the density of pure crystalline material (1.455 g/cc). Once a container has been blown, a commodity may be filled into the container.

Traditionally blow molding and filling have developed as two independent processes, in many cases operated by different companies. In order to make bottle filling more cost effective, some fillers have moved blow molding in house, in many cases integrating blow molders directly into their filling lines. The equipment manufacturers have recognized this advantage and are selling “integrated” systems that are designed to insure that the blow molder and the filler are fully synchronized. Despite the efforts in bringing the two processes closer together, blow molding and filling continue to be two independent, distinct processes. As a result, significant costs may be incurred while performing these two processes separately. Thus, there is a need for a liquid or hydraulic blow molding system suitable for forming and filling a container in a single operation. Moreover, there is a need for a modified preform that is particularly well-suited for molding system that form and fill a container in a single operation

### SUMMARY

This section provides a general summary of the disclosure, and is not a comprehensive disclosure of its full scope or all of its features.

Accordingly, the present disclosure teaches a preform for use in a system for simultaneously forming and filling a container. The preform includes a finish region, a stretch initiation region adjacent to and descending from the finish region, a transition region adjacent to and descending from the stretch initiation region, a body region adjacent to and descending from the transition region, and an end cap region enclosing an end of the body region to define an interior for receiving a forming fluid. The stretch initiation region defines a wall thickness less than a wall thickness of the body region to encourage initial localized stretching in response to the forming fluid prior to stretching within the transition region or body region.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depiction of a heated preform passed into a mold station.

FIG. 2 is a schematic depiction of the system illustrated in FIG. 1 wherein the mold halves close around the preform.

FIG. 3 is a schematic depiction of the system illustrated in FIG. 2 wherein a stretch rod extends into the preform to initiate mechanical stretching and fluid begins to fill the preform cavity.

FIG. 4 is a schematic depiction of the system of FIG. 3 wherein the stretch rod stretches the preform and wherein fluid has been fully accumulated in the preform under little to no ambient pressure.

FIG. 5 is a schematic depiction of the system of FIG. 4 wherein the piston-like device drives the liquid from the pressure source to the preform thereby expanding the preform toward the walls of the mold cavity.

FIG. 6 is a schematic depiction of the system of FIG. 5 wherein the piston-like device has been fully actuated thereby completely transferring an appropriate volume of liquid to the newly formed container and wherein the stretch rod is withdrawing;

FIG. 7 is a schematic depiction of the system of FIG. 6 wherein the mold halves are separate;

FIG. 8 is a schematic depiction of a heated preform passed into a mold station wherein a pressure source including a servo motor system in accordance with the teachings of the present disclosure;

FIG. 9 is a cross-sectional depiction of a preform according to some embodiments of the present teachings;

FIG. 10 is a cross-sectional depiction of a preform according to some embodiments of the present teachings that does not require the use of a stretch rod;

FIG. 11 is a cross-sectional depiction of a preform according to some embodiments of the present teachings having a parabolic transition region;

FIG. 12 is a cross-sectional depiction of a preform according to some embodiments of the present teachings;

FIG. 13 is a schematic depiction of a preform according to FIG. 9 being formed into a resultant container;

FIG. 14 is a schematic depiction of a preform according to FIG. 10 being formed into a resultant container; and

FIG. 15 is a schematic depiction of a preform according to FIG. 11 being formed into a resultant container.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Generally, according to some embodiments of the present teachings, a preform is provided having a stretch initiation zone that can grow and stretch with respect to the volume and pressure of liquid being introduced into the preform. In response to this volume and pressure, an aneurism can develop that can be controlled and conveyed throughout the preform body to the end cap to control the resultant container wall thickness. The volume of liquid introduced can be sufficient to completely fill the preform as it is injection molded. The pressure can be controlled by controlling the volume such that the stretching will begin at the stretch initiation zone without expanding (initially) the body portion. The volume of liquid can continue to increase in the preform such that the preform can elongate into the mold cavity to the full length of the mold. The volume of liquid should be controlled to control this elongation. Once this point is reached, a controller can switch from volumetric control to pressure control and the liquid can be urged into the preform under pressure to completely form and simultaneously fill the container.

### Singe-Step Forming and Filling Discussion

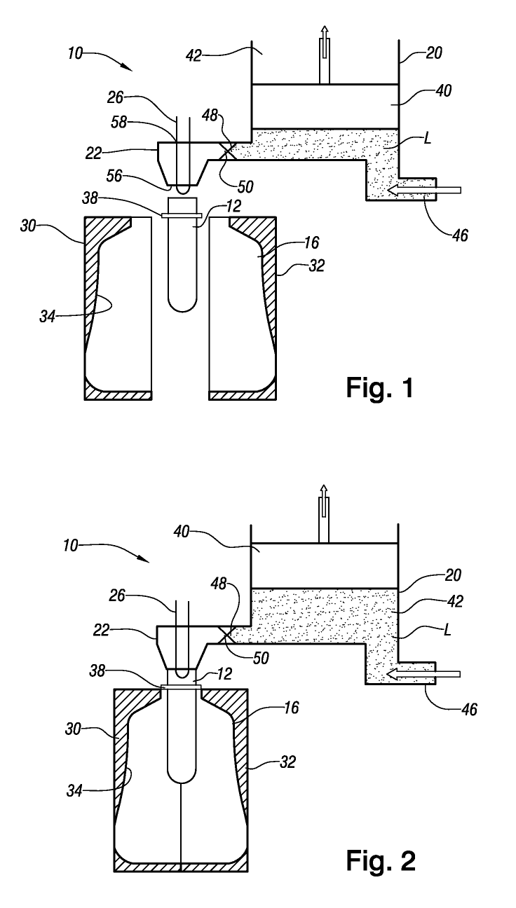

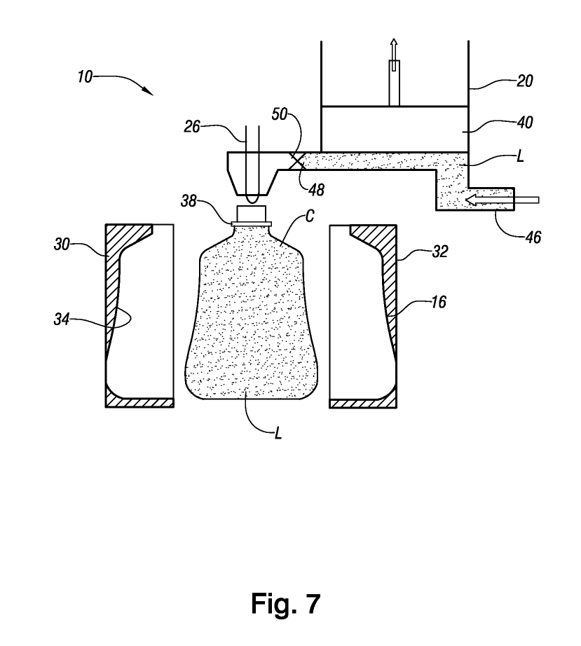

At the outset, it is believed that a description of a mold system that can be used with the preform of the present teachings is beneficial. With regard to FIGS. 1-7, a mold station 10 is provided that utilizes a final liquid commodity L to impart the pressure required to expand a hot preform 12 to take on the shape of a mold thus simultaneously forming and filling the resultant container C (FIG. 7).

With initial reference to FIG. 1, the mold station 10 will be described in greater detail. The mold station 10 generally includes a mold cavity 16, a pressure source 20, a blow nozzle 22 and a stretch rod 26. The exemplary mold cavity 16 illustrated includes mold halves 30, 32 that cooperate to define an interior surface 34 corresponding to a desired outer profile of a blown container. The mold cavity 16 may be moveable from an open position (FIG. 1) to a closed position (FIG. 2) such that a support ring 38 of the preform 12 is captured at an upper end of the mold cavity 16.

In one example, the pressure source 20 can be in the form of, but not limited to, a filling cylinder, manifold or chamber 42 that generally includes a mechanical piston-like device 40 including, but not limited to, a piston, a pump (such as a hydraulic pump) or any other such similarly suitable device, moveable within the filling cylinder, manifold or chamber 42. The pressure source 20 has an inlet 46 for accepting liquid commodity L and an outlet 48 for delivering the liquid commodity L to the blow nozzle 22. It is appreciated that the inlet 46 and the outlet 48 may have valves incorporated thereat. The piston-like device 40 may be moveable in a first direction (upward as viewed in the figures) to draw liquid commodity L from the inlet 46 into the filling cylinder, manifold or chamber 42, and in a second direction (downward as viewed in the figures) to deliver the liquid commodity L from the filling cylinder, manifold or chamber 42 to the blow nozzle 22. The piston-like device 40 can be moveable by any suitable method such as pneumatically, mechanically, electrically (servo), or hydraulically for example. The inlet 46 of the pressure source 20 may be connected, such as by tubing or piping to a reservoir or container (not shown) which contains the final liquid commodity L. It is appreciated that the pressure source 20 may be configured differently.

The blow nozzle 22 generally defines an inlet 50 for accepting the liquid commodity L from the outlet 48 of the pressure source 20 and an outlet 56 (FIG. 1) for delivering the liquid commodity L into the preform 12. It is appreciated that the outlet 56 may define a shape complementary to the preform 12 near the support ring 38 such that the blow nozzle 22 may easily mate with the preform 12 during the forming/filling process. In one example, the blow nozzle 22 may define an opening 58 for slidably accepting the stretch rod 26 used to initiate mechanical stretching of the preform 12 in some embodiments.

In one example, the liquid commodity L may be introduced into the plastic container C during a thermal process, typically a hot-fill process. For hot-fill bottling applications, bottlers generally fill the plastic container C with a liquid or product at an elevated temperature between approximately 185° F. to 205° F. (approximately 85° C. to 96° C.) and seal the plastic container C with a closure (not illustrated) before cooling. In one configuration, the liquid may be continuously circulated within the filling cylinder, manifold or chamber 42 through the inlet 46 whereby the liquid can be heated to a preset temperature (i.e., at a heat source (not illustrated) upstream of the inlet 46). In addition, the plastic container C may be suitable for other high-temperature pasteurization or retort filling processes, or other thermal processes as well. In another example, the liquid commodity L may be introduced into the plastic container C under ambient or cold temperatures. Accordingly, by way of example, the plastic container C may be filled at ambient or cold temperatures such as between approximately 32° F. to 90° F. (approximately 0° C. to 32° C.), and more preferably at approximately 40° F. (approximately 4.4° C.).

With reference now to all figures, an exemplary method of simultaneously forming and filling the plastic container C will be described. At the outset, the preform 12 may be placed into the mold cavity 16. In one example, a machine (not illustrated) places the preform 12 heated to a temperature between approximately 190° F. to 250° F. (approximately 88° C. to 121° C.) into the mold cavity 16. As the preform 12 is located into the mold cavity 16, the piston-like device 40 of the pressure source 20 may begin to draw liquid commodity L into the filling cylinder, manifold or chamber 42 through the inlet 46. The mold halves 30, 32 of the mold cavity 16 may then close thereby capturing the preform 12 (FIG. 2). The blow nozzle 22 may form a seal at a finish of the preform 12. The mold cavity 16 may be heated to a temperature between approximately 250° F. to 350° F. (approximately 93° C. to 177° C.) in order to impart increased crystallinity levels within the resultant container C. In another example, the mold cavity 16 may be provided at ambient or cold temperatures between approximately 32° F. to 90° F. (approximately 0° C. to 32° C.). Liquid commodity L may continue to be drawn into the filling cylinder, manifold or chamber 42 by the piston-like device 40.

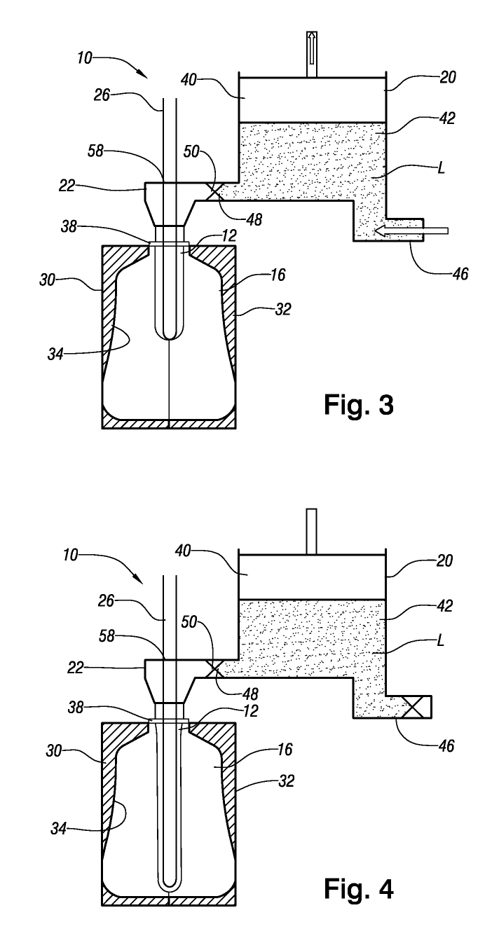

Turning now to FIG. 3, the stretch rod 26 may extend into the preform 12 to initiate mechanical stretching in some embodiments. With reference to FIG. 4, the stretch rod 26 continues to stretch the preform 12 thereby thinning the sidewalls of the preform 12. The volume of liquid commodity L in the filling cylinder, manifold or chamber 42 may increase until the appropriate volume suitable to form and fill the resultant container C is reached. It should be noted that this can be done at any point in time. Moreover, in some embodiments, liquid commodity L can be imparted into the preform during this stretching phase to prevent the preform from contacting the stretch rod and/or to fill the resultant space with liquid rather than air that must later be displaced during filling. At this point, a valve disposed at the inlet 46 of the pressure source 20 may be closed.

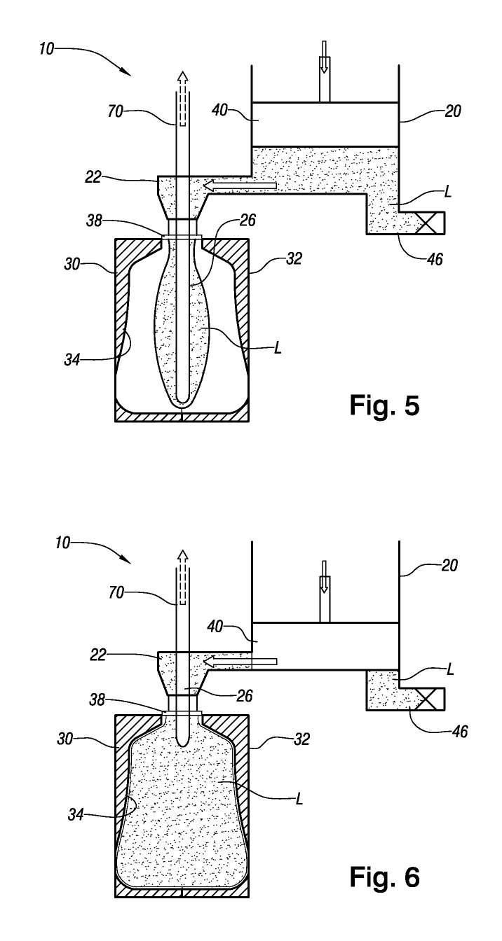

With specific reference to FIG. 5, the piston-like device 40 may begin to drive downward (forming or filling phase) to initiate the rapid transfer of liquid commodity L from the filling cylinder, manifold or chamber 42 to the preform 12. Again, the piston-like device 40 may be actuated by any suitable means such as pneumatic, mechanical, electrical (servo), and/or hydraulic pressure. In one example, the hydraulic pressure within the preform 12 may reach between approximately 100 PSI to 600 PSI. The liquid commodity L causes the preform 12 to expand toward the interior surface 34 of the mold cavity 16. Residual air may be vented through a passage 70 defined in the stretch rod 26 (FIG. 5). As shown in FIG. 6, the piston-like device 40 has completed its drive phase thereby completely transferring the appropriate volume of liquid commodity L to the newly formed plastic container C. Next, the stretch rod 26 may be withdrawn from the mold cavity 16. The stretch rod 26 may be designed to displace a predetermined volume of liquid commodity L when it is withdrawn from the mold cavity 16 thereby allowing for the desired fill level of liquid commodity L within the resultant plastic container C and/or the desired headspace.

Alternatively, liquid commodity L can be provided at a constant pressure or at different pressures during the molding cycle. For example, during axial stretching of the preform 12, liquid commodity L may be provided at a pressure which is less than the pressure applied when the preform 12 is blown into substantial conformity with the interior surface 34 of the mold cavity 16 defining the final configuration of the plastic container C. This lower pressure P₁ may be ambient or greater than ambient but less than the subsequent high pressure P₂. The preform 12 is axially stretched in the mold cavity 16 to a length approximating the final length of the resultant plastic container C. During or just after stretching the preform 12, the preform 12 is generally expanded radially outward under the low pressure P₁. This low pressure P₁ is preferably in the range of between approximately 100 PSI to 150 PSI and can be held for a predetermined amount of time, such as 0.1 to 0.2 seconds. Subsequently, the preform 12 is further expanded under the high pressure P₂ such that the preform 12 contacts the interior surface 34 of the mold halves 30, 32 thereby forming the resultant plastic container C. Preferably, the high pressure P₂ is in the range of approximately 500 PSI to 600 PSI and can be held for a predetermined amount of time, such as 0.1 to 0.2 seconds. As a result of the above method, the base and contact ring of the resultant plastic container C is fully circumferentially formed.

Optionally, more than one piston-like device may be employed during the formation of the resultant plastic container C. For example, a primary piston-like device may be used to generate the low pressure P₁ to initially expand the preform 12 while a secondary piston-like device may be used to generate the subsequent high pressure P₂ to further expand the preform 12 such that the preform 12 contacts the interior surface 34 of the mold halves 30, 32 thereby forming the resultant plastic container C.

With reference to FIG. 7, the fill cycle is shown completed. The mold halves 30, 32 may separate and the blow nozzle 22 may be withdrawn. The resultant filled plastic container C is now ready for post-forming steps such as capping, labeling and packing. At this point, the piston-like device 40 may begin the next cycle by drawing liquid commodity L through the inlet 46 of the pressure source 20 in preparation for the next fill/form cycle. While not specifically shown, it is appreciated that the mold station 10 may include a controller for communicating signals to the various components. In this way, components such as, but not limited to, the mold cavity 16, the blow nozzle 22, the stretch rod 26, the piston-like device 40 and various valves may operate according to a signal communicated by the controller. It is also contemplated that the controller may be utilized to adjust various parameters associated with these components according to a given application.

It should be appreciated that in some embodiments, a movable filling cylinder, manifold, or chamber may not provide sufficient space optimization or facility efficiency. Moreover, in some embodiments, it may be difficult to obtain and/or route pressurized air or liquid from a first location to the preform shaping location.

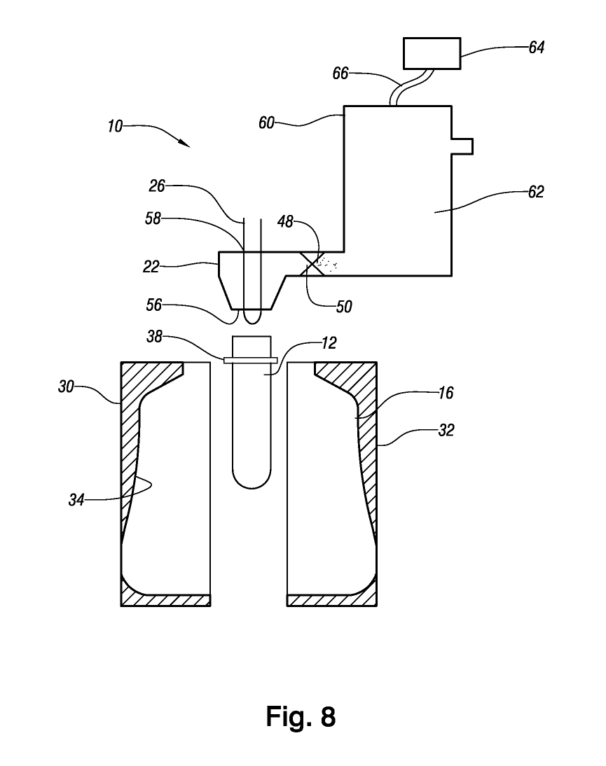

Therefore, in other examples as illustrated in FIG. 8, the pressure source 20 can be in the form of a servo system 60 that generally includes one or more servo motors 62 being actuated by one or more controllers 64 via a line 66. The servo system 60 can be positioned adjacent to the preform shaping location. The servo system 60 can comprise inlet 46 for accepting liquid commodity L and outlet 48 for delivering the liquid commodity L to the blow nozzle 22. The servo motor 62 may be operable in a first direction to draw liquid commodity L from the inlet 46 and output the liquid commodity L from the outlet 48 to the blow nozzle 22 (i.e. forward flow). The servo motor 62, in some embodiments, may also be operable in a second direction to draw liquid commodity L from outlet 48, blow nozzle 22, and/or preform 12 (i.e. reverse flow), which will be discussed in greater detail herein.

In some embodiments, servo motor 62 can be used to overcome some of the difficulties in metering precise and/or minute quantities of commodity L. That is, servo motor 62 is precisely and variably controlled to permit precise metering of a through flow of commodity L and at a variable rate. This precise and variably control can be coupled with a feedback loop to provide active and real-time monitoring and control of the fill process, including stopping of the filling process in the event of a detected issue, such as a blow-out. In this way, the feedback loop can be formed as part of controller 64, with appropriate sensors disposed at any one of a number of locations provide sufficient data to detect a relevant parameter (e.g. pressure sensors, flow sensors, shape sensors, and the like). Because active control of the pressures and quantity of flow of commodity L is often important to the final formed product, the use of servo system 60 is particularly well suited to provide such benefits.

It should be recognized that servo system 60 may require less electrical power to operate, thereby providing additional benefits in terms of reduced electrical consumption and cost.

### Preform Discussion

In light of the above discussion, it should be understood that the preforms used in accordance with a single-step forming and filling operation can be varied to obtain any one of a number of benefits. For example, the preforms of the present teachings can be specifically configured to result in tailored material banding in the resultant container C. That is, the preforms of the present teachings can be configured such that material thickness can be varied along the shoulder portion, sidewall or body portion, and/or base portion of the resultant container C, thereby minimizing the overall weight of the container and maximizing the overall strength of the container in accordance with the container shape. For example, the preforms can be configured such that thicker band of material will land in the waist area of the body portion therefore creating a desirable increase in mechanical properties and ovalization resistance, and an increase in top load performance while allowing the remaining areas of the container to have a thinner wall thickness and subsequently a lower overall weight. Furthermore, the preforms of the present teachings can be configured such that they can be used in connection with the afore-described single-step forming and filling operation without needing application of a mechanical force from optional stretch rod 26. The present teachings further overcome the inherent material mis-leveling found in other single-step forming and filing operations and forming only operations as well.

Although a plurality of preform configurations are envisioned in accordance with the present teachings, it should be recognized that preform 12, 12′, 12″, 12′″ (collectively referred to as 12) can define a generally cylindrical shape and comprise a finish region 102, a stretch initiation region 104, a transition region 106, a body region 108, and an end cap region 110.

Generally, finish region 102 can comprise a conventional shape having a cylindrical wall 112 defining threads 114 for threadedly-engaging a cap (not shown). Finish region 102 can further comprise a seal ring 116 circumferentially disposed about cylindrical wall 112 for sealingly-engaging the cap. Support ring 38 may be used to carry or orient the preform 12 through and at various stages of manufacture. For example, the preform 12 may be carried by the support ring 38, the support ring 38 may be used to aid in positioning the preform 12 in the mold cavity 16, or an end consumer may use the support ring 38 to carry the resultant container C once manufactured. Support ring 38 can, in some embodiments, generally define a lowermost boundary of finish region 102.

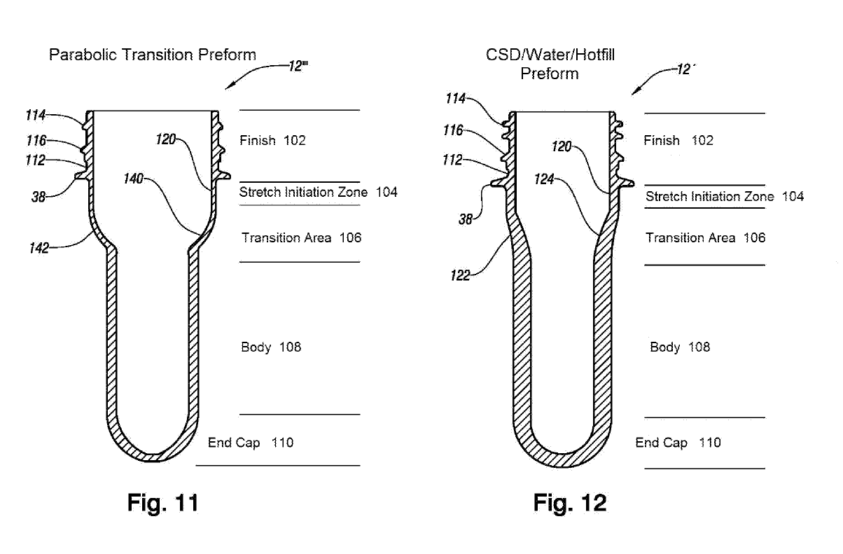

In some embodiments, stretch initiation region 104 extends from and is coupled to finish region 102. Generally, the single-step forming and filling technique of the present teachings often benefit from a more pronounced stretch initiation region 104, as opposed to a stretch “point” commonly used in standard two-step blow molding. In some embodiments described herein, a parabolic transition region 106 (FIGS. 11 and 15) may be used to gradually shift the material stretch during filling to effectively level the wall thickness throughout the shoulder portion and transform into the body portion of the resultant container C. In some embodiments, stretch initiation region 104 represents the thinnest sidewall thickness within the preform and encourages initiation of the stretching during formation.

By way of exemplary sizing, in some embodiments, stretch initiation region 104 can define a minimum wall thickness of about 0.5 mm and a maximum wall thickness of about 2.5 mm. Generally, in some embodiments, it is desirable that stretch initiation region 104 is at least about 0.5 mm thinner than the wall thickness of the body region 108 to encourage stretch initiation. Moreover, in some embodiments, the wall thickness of stretch initiation region 104 can be in the range of about 15% to about 75% of the wall thickness of the body region 108 and, more specifically, in the range of about 40% to about 50% of the wall thickness of the body region 108. Furthermore, in some embodiments, stretch initiation region 104 can define a longitudinal length of about 0.2 mm to about 10 mm and, more specifically, in the range of about 0.5 mm to about 5 mm. In some embodiments, it has been found that the length of stretch initiation region 104 can be about as long as the desired neck straight area of resultant container C.

Transition region 106 descends from stretch initiation region 104 and serves, at least in part, to create an increase in surface area for hydraulic pressure sensitization during initial stages of forming. The transition region 106 can further create an aneurism definition zone and defines how the material will stretch for the remainder of the forming stage. Transition region 106, in some embodiments, can be used to transition material to higher stretch ratio areas of the body of the container. That is, transition region 106 can transition material into areas of resultant container C that experience severe stretching during formation, including areas that may stretch 1.5 to 3.3 times their original size in the preform or areas that may stretch all the way up to about 5 times their original size. Generally, transition region 106 further serves to maintain an even ratio of stretch and material leveling until the desired wall thickness is obtained at the mold sidewalls. Final wall thicknesses can range from about 0.20 mm to about 0.60 mm, but can be as high as about 1.0 mm and as low as about 0.1 mm. The length of transition region 106 can equal about 30% to about 70% of the final container shoulder and neck straight length.

In some embodiments, the weight of plastic contained within stretch initiation region 104 and transition region 106 will be within 90% of the weight contained within the shoulder portion of resultant container C.

Body region 108, in some embodiments, can comprise a nominal wall thickness in the range of about 1.0 mm to about 6.0 mm and, more specifically, in the range of about 1.5 mm to about 2.5 mm. It is anticipated that the nominal diameter should be such that the final stretch ratio is about 1.5 to about 3.3 and no more than about 5 times smaller than the final container side wall diameter. In some embodiments, the weight of plastic contained in the body region 108 of the preform will be within 90% of the weight of the body portion of resultant container C.

End cap region 110, in some embodiments, can comprise a material thickness in the range of about 75% to about 85% less than the wall thickness of the preform body sidewall. In some embodiments, the material thickness of end cap region 110 can be a minimum of about 2.54 mm. End cap region 110 can utilize different inside and outside radii to create a smooth transition from the base portion of resultant container C to the sidewall portion of resultant container C.

In some embodiments, end cap region 110 of preform 12 can be bullet-shaped which is used to shape an upturned POWERFLEX™ base. In such embodiments, one may use two radii that sweep into a line that joins the preform outer sidewall or may use three radii that sweep into the preform inner sidewall. In some embodiments, the weight of plastic contained in the end cap region 110 of the preform 12 will be within 90% of the weight of the base portion of resultant container C.

Generally, several common features of preform 12 have been found to be beneficial. Specifically, an overall stretch ratio—that is, the hoop stretch vs. the axial stretch—between about 3 and about 12 maintains desirable material characteristics. The preferred stretch ratio is dependent upon product fill temperatures, however. That is, for a fill temperature between about 36° F. and about 100° F., a stretch ratio of about 6 to about 10 has been found to provide sufficient material characteristics. Similarly, for a fill temperature between about 100° F. to about 195° F., a stretch ratio of about 4 to about 8 has been found to provide sufficient material characteristics.

The volume of material contained within the preform 12 is related to the surface area of the container (e.g. ratio of cc's to cm²). By way of example, for water-based product filled at room temperatures (50-100° F.), this ratio generally equals about 40 to about 66. However, for CSD (carbonated) product filled at cold temperatures (34-45° F.), this ratio generally equals about 24 to about 40. Generally, the material wall thickness should be sufficient to maintain enough specific heat within the preform walls to facilitate forming with the aforementioned temperature of product.

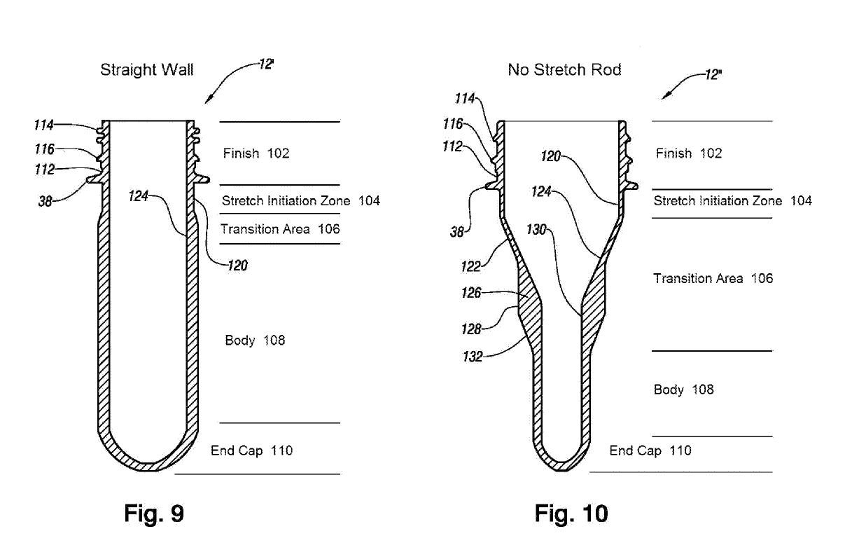

With specific reference to FIGS. 9-15, it should be understood that the preform 12 of the present teachings can include any one of a number of profile configurations that, in accordance with the description herein, provide manufacturing benefits particularly tailored to final container shapes, properties, and/or characteristics. In some embodiments, these profile configurations provide enhanced molding response, particularly when molding with a fluid or liquid.

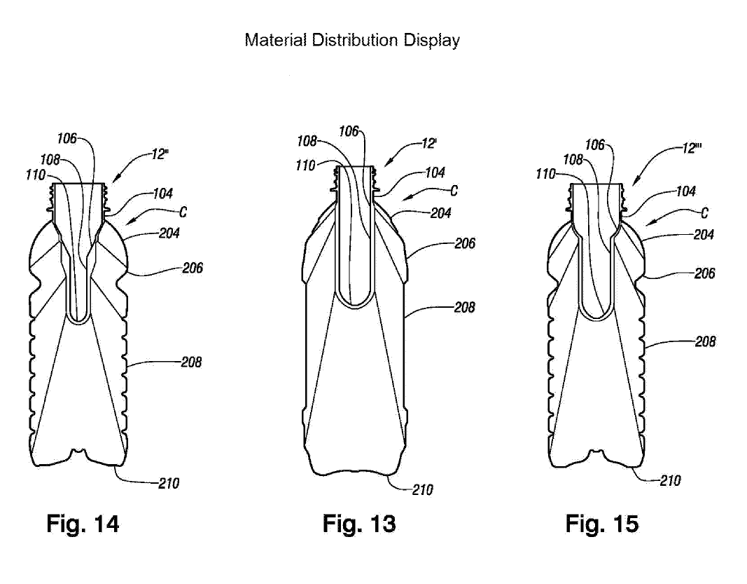

In some embodiments, as illustrated in FIGS. 9, 12, and 13, a straight wall preform configuration, generally referenced by 12′, can minimize hoop features and hoop stretch, which can maximize final container geometry design freedom. The straight wall preform 12′ may be particularly well-suited for use in small container sizes adapted to contain, for example, water, CSD, and liquor applications. As seen in FIG. 13, the distribution of material is illustrated wherein the material from stretch initiation region 104 is used to form a shoulder portion 204 of resultant container C, transition region 106 is used to form a transition portion 206 of resultant container C, body region 108 is used to form a body portion 208 of resultant container C, and end cap region 110 is used to form base portion 210. In this way, formation of the resultant container C is completed by beginning molding at the stretch initiation region 104 and permitting propagation of the molding event down the length of the preform.

With particular reference to FIG. 9, preform 12′ can comprise finish region 102 having a generally straight wall configuration defining a draft angle of about 0.3° to 0.6° extending from the upper most portion to about the support ring 38 to improve demolding during the injection process. Stretch initiation region 104 can comprise a reduced wall thickness portion 120 relative to wall thickness of transition region 106 and/or body region 108. In some embodiments, such as in FIG. 12, an outer diameter portion 122 of transition region 106 can converge toward a longitudinal axis of preform 12′. In some embodiments, an inner diameter portion 124 can likewise converge toward the longitudinal axis. As can be seen, the converging of outer diameter portion 122 and inner diameter portion 124 can differ in inclination and length. The net effect can produce an increasing wall thickness within the transition region 106. However, it should be understood that in some embodiments, such as FIG. 9, inner diameter portion 124 of transition region 106 can be generally uniform relative to other portions of preform 12′, such as the finish region 102, stretch initiation region 104, and/or body region 108.

In some embodiments, transition region 106 can define a wall thickness of in the range of about 0.8 mm to about 2.5 mm. Furthermore, in some embodiments, the wall thickness of transition region 106 can be in the range of about 35% to about 75% of the wall thickness in the body region 108. Body region 108 can be generally uniform and define a generally constant wall thickness, such as, but not limited to, about 1.0 mm to about 4.1 mm.

In some embodiments, as illustrated in FIGS. 10 and 14, a preform configuration that can be used without the need for stretch rod 26, generally referenced by 12″, is provided. The no-stretch rod preform 12″ may be particularly well-suited to form smaller and/or small-diameter containers adapted to contain, for example, DPD, hot-fill, and performance-type containers. Moreover, the no-stretch rod preform 12″ may be well suited for high axial stretch applications due to the addition of material within the transition region 106. It should be appreciated, however, that the thickened portion in transition region 106 is optional. In some embodiments, the minimum inside diameter of the no-stretch rod preform 12″ can be as small as about 10 mm. As seen in FIG. 14, the distribution of material is illustrated wherein the material from stretch initiation region 104 is used to form a shoulder portion 204 of resultant container C, transition region 106 is used to form a transition portion 206 of resultant container C, body region 108 is used to form a body portion 208 of resultant container C, and end cap region 110 is used to form base portion 210.

With particular reference to FIG. 10, preform 12″ can comprise finish region 102 having a generally straight wall configuration defining a draft angle of about 0.3° to 0.6° extending from the upper most portion to about the support ring 38 to improve demolding. Stretch initiation region 104 can comprise a reduced wall thickness portion 120 relative to wall thickness of transition region 106 and/or body region 108. In some embodiments, such as in FIG. 10, an outer diameter portion 122 of transition region 106 can converge toward a longitudinal axis of preform 12″. In some embodiments, an inner diameter portion 124 can likewise converge toward the longitudinal axis. As can be seen, the converging of outer diameter portion 122 and inner diameter portion 124 can differ in inclination and length. The net effect can produce an increasing wall thickness within the transition region 106 resulting in a thickened wall portion 126. Thickened wall portion 126 can specifically comprise a generally straight outer wall 128 and a generally straight inner wall 130. It should be noted that draft angles can be used to improve injection molding of preform 12″. Thickened wall portion 126 comprises additional material sufficient to be blow molded into transition portion 206 of resultant container C. Once past the thickened wall portion 126, a second outer diameter portion 132 can converge toward the longitudinal axis of preform 12″, similar to outer diameter portion 122.

Because preform 12″ can be used without the need for a stretch rod, overall manufacturing can be greatly improved through reduced heating times and improved injection efficiencies and smaller diameter finishes for resultant container C can be created that reduce container weight and material usage.

In some embodiments, transition region 106 can define a wall thickness in the range of about 0.8 mm to about 2.5 mm. Furthermore, in some embodiments, the wall thickness of transition region 106 can be in the range of about 35% to about 75% of the wall thickness in the body region 108. Body region 108 can be generally uniform and define a generally constant wall thickness, such as, but not limited to, about 1.0 mm to about 4.1 mm.

In some embodiments, as illustrated in FIGS. 11 and 15, a preform configuration that comprises a parabolic transition region 106, generally referenced by 12′″, is provided. As described herein, a parabolic transition region 106 may be used to gradually shift the material stretch during forming and filling to effectively level the wall thickness throughout the shoulder and transform into the body of the container. Moreover, the parabolic preform 12′″ may be particularly well-suited to form containers that have larger finish areas, such as those having 33 mm or larger finishes, and containers adapted to contain, for example, hot-fill product. Moreover, the parabolic preform 12′″ may be well suited for high axial stretch and/or complex applications. As seen in FIG. 15, the distribution of material is illustrated wherein the material from stretch initiation region 104 is used to form a shoulder portion 204 of resultant container C, transition region 106 is used to form a transition portion 206 of resultant container C, body region 108 is used to form a body portion 208 of resultant container C, and end cap region 110 is used to form base portion 210.

With particular reference to FIG. 11, preform 12′″ can comprise finish region 102 having a generally straight wall configuration defining a draft angle of about 0.3° to 0.6° extending from the upper most portion to about the support ring 38 to improve injection demolding. Stretch initiation region 104 can comprise a reduced wall thickness portion 120 relative to wall thickness of transition region 106 and/or body region 108. In some embodiments, such as in FIG. 11, transition region 106 can be parabolic in cross-section. That is, transition region 106 can define an inner surface 140 defining a parabolic shape. Transition region 106 can further define an outer surface 142 offset from inner surface 140. Outer surface 142 can similarly be parabolic; however, it should be understood that outer surface 142 need not define an identical parabolic shape and can define any of desired profile. Nonetheless, this parabolic shape of inner surface 140 of transition region 106 enables material to stretch evenly during the initial stages of the container formation.

When the container begins to take shape at the stretch initiation region 104, an aneurism is formed with the liquid inside of the preform. This aneurism begins to develop in the stretch initiation phase, and is physically seen to begin growing from the stretch initiation region 104. Once the aneurism is started, the parabolic shape (or other shapes described herein) allows the hydraulic forces to affect equal stretching and material leveling on the preform from the shoulder portion 204 and into the transition portion 206 and finally into the body portion 208 of the container (see FIG. 15). The parabolic shape is required to transition the material from the initial stretch aneurism into a higher stretch ratio, typically between 1.5 and 3.3 times, but up to 5 times the initial shape. The parabolic shape allows the aneurism to grow in size, thus stretching the material to its full stretch capability and maintaining an even ratio of stretch and leveling until the desired wall thickness is achieved, typically between about 0.2 and about 0.6 mm, but could be as low as 0.1 mm and as thick as 1.0 mm. It should be recognized that the general forming operation described herein may be equally applicable to alternative embodiments.

The parabolic transition also transitions the wall thickness of the stretch initiation region 104 into the wall thickness of the body portion 208. The nominal wall thickness of the body portion 208 can be between about 1.0 mm to about 4.1 mm. In some embodiments, the thickness of the end cap region 110 near the injection gate can be about 40% to 60% less than that of the body wall thickness. The length of the preform will then determine the end body weight of the finished container.

In some embodiments, the axial stretch ratio of the preform to container should be a minimum of 1.0 times larger and a maximum of 4 times the preform length to container length. The hoop stretch ratio should be a minimum of 0.5 and a maximum of 5 times the diameter of the container. The outside diameter of the preform at the end cap region 110 should be at least 0.5 mm larger than the ID of the finish diameter or greater than 2.0 mm smaller to prevent nesting of the preforms during manufacture and transport.

The parabolic transition region 106 is so designed that it equals about 30% to about 70% of the length of shoulder portion 204 of the resultant container C with a preferred range of about 50% to about 60%. The preform parabolic transition shape should, in some embodiments, also have a primary radii of ⅙ to ⅓ the container shoulder radius to facilitate the even transition of material stretch during aneurism formation.

In the exemplary method described herein, the preforms may be passed through an oven in excess of 212° F. (100° C.) and immediately filled and capped. In this way, the opportunity for an empty container to be exposed to the environment where it might become contaminated is greatly reduced. As a result, the cost and complexity of aseptic filling may be greatly reduced.

In some instances where products are hot filled, the package must be designed to accommodate the elevated temperature that it is exposed to during filling and the resultant internal vacuum it is exposed to as a result of the product cooling. A design that accommodates such conditions may require added container weight. Liquid/hydraulic blow molding offers the potential of eliminating the added material required for hot fill process and as a result, lowering the package weight.

The method described herein may be particularly useful for filling applications such as isotonic, juice, tea and other commodities that are susceptible to biological contamination. As such, these commodities are typically filled in a controlled, sterile environment. Commercially, two ways are typically used to achieve the required sterile environment. In Europe, one primary method for filling these types of beverages is in an aseptic filling environment. The filling operation is performed in a clean room. All of the components of the product including the packaging must be sterilized prior to filling. Once filled, the product may be sealed until it is consumed preventing any potential for the introduction of bacteria. The process is expensive to install and operate. As well, there is always the risk of a bacterial contaminant breaking through the operational defenses and contaminating the product.

There are many other bottled products where this technology may be applicable. Products such as dairy products, liquor, household cleaners, salad dressings, sauces, spreads, syrups, edible oils, personal care items, and others may be bottled utilizing such methods. Many of these products are currently in blow molded PET containers but are also in extrusion molded plastic containers, glass bottles and/or cans. This technology has the potential of dramatically changing the economics of package manufacture and filling.

While much of the description has focused on the production of PET containers, it is contemplated that other polyolefin materials (e.g., polyethylene, polypropylene, etc.) as well as a number of other plastics may be processed using the teachings discussed herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A preform for use in a system for simultaneously forming and filling a container, said preform comprising:
a finish region;
a stretch initiation region adjacent to and descending from said finish region;
a transition region adjacent to and descending from said stretch initiation region;
a body region adjacent to and descending from said transition region; and
an end cap region enclosing an end of said body region to define an interior for receiving a forming fluid,
wherein said stretch initiation region defines a wall thickness less than a wall thickness of said body region to encourage initial localized stretching therein in response to the forming fluid prior to stretching within said transition region or body region.

2. The preform according to claim 1, further comprising:
a continuous interior surface extending from said stretch initiation region to said body region having a draft angle of about 0.3° to about 0.6°.

3. The preform according to claim 1, further comprising:
a first outer surface disposed within said transition region being inwardly inclined toward a longitudinal axis of the preform.

4. The preform according to claim 3, further comprising:
an inner surface disposed within said transition region being inwardly inclined toward said longitudinal axis of the preform.

5. The preform according to claim 4 wherein said inner surface is inwardly inclined toward said longitudinal axis at a different angle than said first outer surface.

6. The preform according to claim 4, further comprising:
a second outer surface disposed within said transition region being inwardly inclined toward said longitudinal axis of the preform, said first outer surface, said inner surface, and said second outer surface together defining an enlarged wall thickness portion within said transition region.

7. The preform according to claim 3, further comprising:
an inner surface disposed within said transition region being parabolic shaped.

8. The preform according to claim 3, further comprising:
an inner surface disposed within said transition region being shaped to encourage formation of an aneurysm during the simultaneously forming and filling.

9. The preform according to claim 1 wherein the preform is configured such that upon application of the forming fluid within the preform, said stretch initiation region, said transition region, and said body region expand respectively and consecutively.

10. A preform for use in a system for simultaneously forming and filling a container, said preform comprising:
a finish region;
a first stretch initiation region;
a first transition region;
a body region; and
an end cap region enclosing an end of said body region to define an interior for receiving a forming fluid,
wherein said first stretch initiation region defines a wall thickness less than a wall thickness of said body region to encourage initial localized stretching therein in response to the forming fluid prior to stretching within said transition region or body region.

11. The preform according to claim 10, further comprising:
a second stretch initiation region; and
a second transition region,
wherein said second stretch initiation region defines a wall thickness less than a wall thickness of said body region to encourage initial localized stretching at said second stretch initiation region at least in part concurrently with said initial localized stretching of said first stretch initiation region in response to the forming fluid.

12. A method of simultaneously forming and filling a preform to manufacture a container, said method comprising:
providing a preform having a stretch initiation region, a body region, and an end cap region; and
introducing a liquid commodity into said preform such that an aneurism is formed at said stretch initiation region and conveyed from said stretch initiation region to said body region to urge the preform against a mold cavity to control a resultant container wall thickness, a volume of said liquid commodity being sufficient to fill a resultant container and remain within said resultant container.

13. The method according to claim 12 wherein said introducing a liquid commodity is initially controlled with respect to volume to control said conveyance of said aneurism and finally controlled with respect to pressure to urge the preform into contact with the mold cavity.
